(19) United States
(12) Patent Application Publication
(10) Pub. No.: US 2008/0248328 A1
(43) Pub. Date: Oct. 9, 2008

(54) Process for Preparing a Zeolite-Containing Film

(75) Inventors: Yoshitaka Hamada, Joetsu-shi (JP); Masaru Sasago, Osaka (JP); Hideo Nakagawa, Shiga (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: Shin-Etsu Chemical Co., Ltd.; Matsushita Electric Industrial Co., Ltd.

(21) Appl. No.: 12/060,480

(22) Filed: Apr. 1, 2008

(30) Foreign Application Priority Data
Apr. 3, 2007 (JP) 2007-097495

(51) Int. Cl. B32B 9/00; B05D 3/02; B05D 5/12

(52) U.S. Cl. 428/688; 427/384; 427/122

(57) ABSTRACT

The invention provides a preparation process of a zeolite-containing film which can raise a zeolite component therein, control the physical properties of the surface, and provide a highly smooth film. The process for preparing a zeolite-containing film has a step of forming a precursor film containing an amorphous silicon oxide portion and a zeolite-like recurring portion by using a material having an amorphous silicon oxide portion and a material having a zeolite-like recurring portion; and a dry gel conversion step of heating the precursor film in the presence of water vapor in order to grow the zeolite-like recurring portion. In this process, the material having an amorphous silicon oxide portion and/or the material having a zeolite-like recurring portion contain(s) a silicon atom bonded to the carbon atom of an organic group containing at least one carbon group.

### CROSS REFERENCE TO RELATED APPLICATIONS

This application claims the benefit of Japanese Patent Application No. 2007-097495, filed Apr. 3, 2007, which is incorporated herein by reference in its entirety and for all purposes.

### FIELD OF THE INVENTION

The present invention relates to a process for preparing a zeolite-containing film by dry gel conversion. The invention particularly relates to use of the method for a low-dielectric-constant dielectric film and a semiconductor device having the low-dielectric-constant dielectric film therein.

### BACKGROUND OF THE INVENTION

In the fabrication of semiconductor integrated circuits, as their integration degree becomes higher, an increase in interconnect delay time due to an increase in interconnect capacitance, which is a parasitic capacitance between metal interconnects, prevents their performance enhancement. The interconnect delay time is so-called an RC delay which is in proportion to the product of electric resistance of metal interconnects and the static capacitance between interconnects. Reduction in the resistance of metal interconnects or reduction in the capacitance between interconnects is necessary for reducing this interconnect delay time.

The reduction in the resistance of an interconnect metal or the interconnect capacitance can prevent even a highly integrated semiconductor device from causing an interconnect delay, which enables miniaturization and high speed operation of it and moreover, minimization of the power consumption.

In order to reduce the resistance of metal interconnects, semiconductor device structures using copper as metal interconnects have recently replaced those using conventional interconnects made of aluminum. Use of copper interconnects alone, however, has limits in accomplishing performance enhancement so that reduction in the interconnect capacitance is an urgent necessity for further performance enhancement of semiconductor devices.

One of the possible methods for reducing an interconnect capacitance is a reduction in the dielectric constant of an interlayer dielectric film formed between metal interconnects. As such a low-dielectric-constant dielectric film, a porous film is being investigated instead of a conventionally used silicon oxide film.

In particular, as a material having a dielectric constant of 2.5 or less and suited for an interlayer dielectric film, a porous film is only a practical one. Various formation processes of a porous film are therefore proposed. For example, it was supposed to be possible to obtain a film made of a silicon oxide material and having a number of pores by synthesizing a precursor solution of a siloxane polymer containing a thermally unstable organic component, applying the precursor solution onto a substrate to form a coated film, and decomposing and evaporating the organic component by heat treatment to form a number of pores.

Many materials hitherto reported however did not simultaneously satisfy the requirements for a sufficiently low dielectric constant and high mechanical strength, because many fine pores are formed in a film without changing the material, the strength of the resulting film depends on the volume of the non-pore portion, in other words, it decreases in proportion to the density of the pores.

One approach to form a film having both a low dielectric constant and high mechanical strength, there is a method of using zeolite. Zeolite is a metal oxide of silicon, aluminum and the like which becomes porous by having a certain crystal-like recurring structure. Zeolite composed only of a silicon oxide is called silicalite. Zeolite is expected to have strength higher than that of a conventional amorphous silicon oxide film obtained by sintering a silicon polymer, because it has a crystal structure so that there is an attempt to form a film, on a substrate, by using zeolite having a relatively small particle size and employ it as an dielectric film (Adv. Mater., 13, No. 10, May 17, 746(2001)). As an improvement of this attempt, a process of forming a film by incorporating zeolite in an organosilicon polymer (Japanese Patent Provisional Publication No. 2002-030249) and the like are known. The present inventors have announced a process (Japanese Patent Provisional Publication No. 2005-216895) using zeolite having a silicon amorphous side chain.

Another process is to form a silica film and grow zeolite crystals in the film by using seed crystals of zeolite and this process is known as a dry gel conversion method. For example, Japanese Patent Provisional Publication No. 2001-31416 discloses a process for preparing a separation membrane by bringing zeolite seed crystals having an atomic arrangement (which will hereinafter be called “zeolite-like recurring structure or zeolite-like recurring portion) constituting zeolite crystals into contact with amorphous silica and growing zeolite crystals from the zeolite seed crystals in the presence of an amine and water vapor to convert a silica film into a zeolite film.

Zeolite is also used for the formation of interlayer dielectric films. U.S Patent No. 20050282401A1 discloses production of a zeolite film by forming a silica film containing zeolite particles and then subjecting it to the dry gel conversion method.

### SUMMARY OF THE INVENTION

When zeolite is used, formation of a porous film having higher mechanical strength than that of an amorphous silicon oxide film available from an organosilicon polymer is expected. If, after the formation of a coated film, a zeolite content in the film can be increased by the dry gel conversion method, not only mechanical strength but also porosity is expected to be improved.

The zeolite film obtained by the process of U.S Patent No. 20050282401A1 has however two problems. One is that the film thus formed has high hydrophilicity and if it is left to stand, it changes drastically by absorbing moisture and having an increased dielectric constant. As a result, it does not function as a low dielectric constant film without giving surface treatment with a hydrophobic agent immediately after completion of the porous film by sintering. The other one is that since growth of zeolite in the film cannot be controlled easily, the zeolite film thus obtained contains a large zeolite grain aggregate. When it is used in a minute semiconductor device, the surface must therefore be subjected to planarizing treatment after the growing reaction of zeolite.

An object of the invention is to overcome the above-described problems and provide a process for obtaining, by a dry gel conversion method, a film whose surface physical properties such as hydrophilicity can be controlled. Another object is to provide a method of obtaining a highly smooth film by using the dry gel conversion even after a zeolite structure is grown in the film.

The present inventors have carried out a fundamental investigation on a range to which dry gel conversion can be applied. As a result of extensive investigation on various silicon-oxide film-forming compositions containing a zeolite-like recurring structure, it has been found contrary to their expectation that even if a silicon oxide polymer obtained by introducing—in order to impart controllability of surface physical properties to the resulting film—an organic substituent having one or more carbon numbers to be bonded to a silicon atom into some silicon units of an amorphous silicon oxide polymer which is a material having an amorphous silicon portion to be incorporated in a zeolite-like recurring portion is used, the zeolite-like recurring portion can be grown in the coated film by using the dry gel conversion method in the presence of a material having a zeolite-like recurring structure which will serve a nucleus for re-construction of bonding; and this process enables preparation of a film having controlled hydrophilicity on the surface thereof and containing the zeolite-like recurring portion which has been grown and increased in number.

With respect to a material, in the film-forming composition, for providing seed crystals, that is, a zeolite-like recurring portion which will be a nucleus for incorporating the silicon oxide portion in an amorphous state in the zeolite-like recurring portion, the present inventors have also carried out an investigation on a film-forming composition obtained by modifying the surface of the material having a zeolite-like recurring portion with a silicon oxide chain having a silicon atom bonded to a carbon atom of an organic group having one or more carbon numbers, thereby making the surface activity of the material having a zeolite-like recurring portion controllable. It has been found that even if the surface of the material having a zeolite-like recurring portion has been inactivated by the substituted organic group, use of the dry gel conversion method promotes the growth of the zeolite-like recurring portion in the film, increases its number, and improves a porosity due to an increase in the number of micropores, and at the same time when zeolite seed crystals having activity thus controlled are used, a film having a smooth surface and containing the zeolite-like recurring portion which has been grown and increased in number can be obtained, leading to the completion of the invention.

Although it is difficult to form a film by application of a material composed only zeolite but a material having the zeolite-like recurring portion and having a surface modified with a silicon oxide chain having a silicon atom bonded to the carbon atom of an organic group having one or more carbon numbers can be formed into a film without adding a silicon oxide polymer material in an amorphous state as a binder for film formation. It has therefore been found that when a film obtained by applying a film-forming composition having no binder, having a zeolite-like recurring portion, and containing a material modified with a silicon oxide chain having a silicon atom bonded to the carbon atom of an organic group having one or more carbon numbers is subjected to the dry gel conversion method, a film containing the zeolite-like recurring portion which has been grown and increased in number can be obtained.

In addition, zeolite-like fine particles which are presumed to have an organic-group-containing silicon atom incorporated in a zeolite crystal structure thereof by the addition of a hydrolyzable silane compound having a silicon atom bonded to the carbon atom of an organic group having one or more carbon numbers, followed by a strong maturing reaction enable preparation of a solution containing only fine particles having a particle size as minute as, for example, 80 nm or less, which are conventionally difficult to obtain. When the zeolite-like fine particles obtained by the above process and having a particle size of approximately 30 nm are used, a considerably smooth precursor film is available because they scarcely contain particles having an unusual particle size. The present inventors have found that when the resulting precursor film is treated by the dry gel conversion method, the zeolite-like structure can be increased further between zeolite fine crystals though the surface has already been strongly inactivated, the number of micropores can be increased, and a film having a considerably smooth surface can be obtained in spite of an increase in the zeolite-like structure.

In the invention, there is thus provided a preparation process of a zeolite-containing film which comprises subjecting a dry gel conversion method—in which a precursor film having a silicon oxide portion in an amorphous state and a zeolite-like recurring portion is heat-treated in the presence of water vapor to grow the zeolite-like recurring portion in the film—to a precursor film containing a second material which has a zeolite-like recurring portion and will serve as a nucleus of the growth of the zeolite-like recurring portion and a first material which has a silicon oxide portion in an amorphous state and is to be incorporated in the zeolite-like recurring portion, either or both of the materials containing a silicon atom bonded to the carbon atom of an organic group having one or more carbon numbers. The conventional dry gel conversion method is a method of promoting crystallization of amorphous silica into a zeolite structure with zeolite crystals as seed crystals while heating in the presence of water vapor with a nitrogen compound or the like as a catalyst. Even if either or both the seed crystals or amorphous silica contains a silicon atom substituted with an organic group which will act as a factor for controlling physical properties, a film having a zeolite structure grown therein can be obtained by the treatment in accordance with the dry gel conversion method.

In one preferred mode of the preparation process of a zeolite-containing film according to the invention, there is provided the preparation process of a zeolite-containing film wherein the second material having a zeolite-like recurring portion is composed of a zeolite-like recurring portion and a silicon atom bonded to the carbon atom of an organic group having one or more carbon numbers. Although the surface activity of the zeolite particles is suppressed by bonding of the silicon atom substituted with an organic group to the second material having a zeolite-like recurring portion, the dry gel conversion method is effective even if the inactivated particles are used as seed crystals so that a zeolite-containing film having a highly smooth surface is available.

In another preferred mode of the preparation process of a zeolite-containing film according to the invention, there is provided the preparation process of a zeolite-containing film, wherein the first material having a silicon oxide portion in an amorphous state is a silicon oxide polymer containing a silicon atom bonded to the carbon atom of an organic group having one or more carbon numbers. The surface physical properties of the finally available film such as hydrophilicity can be suppressed by introducing a silicon unit substituted with the organic group into the silicon oxide polymer, but the dry gel conversion method is effective even when a material containing a silicon unit substituted with an organic group is used as a first material for providing the silicon oxide portion in an amorphous state.

In a still further preferred mode of the invention, there is also provided the preparation process of a zeolite-containing film, wherein the second material having a zeolite-like recurring portion is composed of a zeolite-like recurring portion and a silicon atom bonded to the carbon atom of an organic group having one or more carbon numbers and the first material containing a silicon oxide portion in an amorphous state is a silicon oxide polymer containing a silicon atom bonded to the carbon atom of an organic group having one or more carbon numbers. Also in this case, a zeolite-containing film having micropores increased in number can be obtained by the dry gel conversion method.

In a still further preferred mode of the invention, there is also provided the preparation process of a zeolite-containing film, wherein the third material having a zeolite-like recurring portion and a silicon oxide portion in an amorphous state and containing a silicon atom bonded to a carbon atom of an organic group having one or more carbon numbers. It is possible to incorporate, in one molecule, the zeolite-like recurring portion and the silicon oxide portion in an amorphous state and the dry gel conversion method of the invention can also be used for, as one of such materials, silica particles having partially a zeolite-like recurring structure.

The invention also provides a zeolite-containing film formed by the above-described process. The film formed by the process has an improved porosity due to an increase in the number of micropores and has improved mechanical strength due to the growth of zeolite crystals, though silicon atoms substituted with an organic group are present in the film.

A zeolite-containing porous film is available by giving or not giving an additional treatment to the above-described zeolite-containing film and then sintering it. The additional treatment is, for example, exposure to high-energy radiation such as ultraviolet rays and electron beams.

The invention also provides a zeolite-containing porous film obtained by the above-described process.

One of the important applications of the invention is a manufacturing process of a semiconductor device by employing the above-described preparation process of a zeolite-containing porous film during a step of forming a low-dielectric-constant dielectric film.

This makes it possible to provide a semiconductor device using the zeolite-containing porous film as a low-dielectric-constant dielectric film.

The zeolite/zeolite crystals used herein indicate a silicon oxide polymer which has been covalently bonded and has a specific three-dimensional recurring structure. It has micropores derived from the crystal structure. The term “micropores” means not only small pores but also micropores derived from the zeolite-like recurring portion. The term “zeolite-like recurring portion” means not only typical zeolite crystals in a narrow sense having a long-range regularity but also it embraces those not belonging to a specific type and having fluctuations in the recurring regularity and those not having a long-range regularity but having, in a short span, an atomic arrangement regularity based on the crystal structure. The term “amorphous silica/silica” means a non-crystalline silicon-oxide recurring portion and it does not have the above-described micropores.

According to the preparation process of a zeolite-containing film of the invention, a film having a zeolite structure grown therein can be obtained by using the dry gel conversion method even if a silicon atom substituted with an organic group is present as a factor for controlling the physical properties in either or both of a material having a zeolite-like recurring portion and a material having a silicon oxide portion in an amorphous state. Further, by the preparation process, a zeolite-containing film having an improved porosity and mechanical strength and having controllable surface physical properties can be obtained.

Moreover, since the hydrophilicity on the surface of the zeolite-containing film of the invention is readily controlled by an organic group containing a carbon atom bonded to a silicon atom, it can be used as a porous low-dielectric-constant dielectric film in semiconductor devices.

When a material having surface activity controlled by the substitution with an organic group is used as the material having a zeolite-like recurring portion, a smooth film can be obtained so that it can be used in semiconductor devices without treatment such as CMP.

### BRIEF DESCRIPTION OF THE DRAWINGS

FIG. 1 is a schematic cross-sectional view illustrating one example of the semiconductor device of the present invention.

### DETAILED DESCRIPTION OF THE PREFERRED EMBODIMENT

The present invention now will be described more fully hereinafter. However, this invention may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural referents unless the context clearly dictates otherwise.

The conventional dry gel conversion method is a method of bringing zeolite seed crystals into contact with a silicon oxide film in an amorphous state or dispersing the seed crystals in the film to accelerate re-arrangement of the amorphous silicon oxide portion by heating in a water-vapor-containing atmosphere in the presence of a basic catalyst such as tetrapropylammonium contained in the film or an amine contained in the water vapor, whereby the zeolite-recurring portion is grown in the film. In the dry gel conversion method of the invention, on the other hand, as a material of a film-forming composition for forming a precursor film, used are a material having a silicon oxide portion in an amorphous state and a material having a zeolite-like recurring portion, either or both of the materials containing a silicon atom bonded to the carbon atom of an organic group having one or more carbon numbers.

First, the material of the invention having a silicon oxide portion in an amorphous state will be described.

The material having a silicon oxide portion in an amorphous state which is preferably used in the invention is either simple amorphous silica (in this case, the material having a zeolite-like recurring portion contains a silicon atom bonded to the carbon atom of an organic group having one or more carbon numbers) or a silicon oxide polymer (in this case, the material having a zeolite-like recurring portion may contain or not contain a silicon atom substituted with an organic group) containing a silicon atom bonded to the carbon atom of an organic group having one or more carbon numbers, depending on a material to be used in combination.

In the former case, amorphous silica obtained by any known process can be used. Particularly when it is used in semiconductor devices, it must have a markedly low metal impurity concentration so that use of amorphous silica obtained by hydrolysis and condensation of, for example, a tetraalkoxysilane in an alkali catalyst such as metal-free tetramethylammonium hydroxide, organic amine or ammonia is preferred.

In the latter case, on the other hand, physical properties of the film such as hydrophilicity can be controlled using a material having a zeolite-like recurring portion and containing a silicon atom substituted with the organic group. Alternatively, it is effective to use, as the material having a silicon oxide portion in an amorphous state, a silicon oxide polymer containing a silicon atom bonded to the carbon atom of an organic group having one or more carbon numbers, thereby controlling the physical properties by the presence of the organic group which the material has.

Examples of the material usable advantageously for the silicon oxide polymer containing a silicon atom bonded to the carbon atom of an organic group having one or more carbon numbers include materials obtained by hydrolysis and condensation of a tetravalent hydrolyzable silane, which can provide amorphous silica to be used in the conventional dry gel conversion method, in the presence of one or more hydrolyzable silane compounds having a silicon atom bonded to the carbon atom of an organic group having one or more carbon numbers.

The organic group may be a substituted or unsubstituted hydrocarbon. Examples of it include aliphatic hydrocarbon groups, aromatic hydrocarbon groups, aliphatic hydrocarbon groups substituted with aromatic hydrocarbon groups, and aromatic hydrocarbon groups substituted with aliphatic hydrocarbon groups. They may contain further any substituent containing a hetero atom insofar as it is not a substituent such as carboxyl group having strong interaction with a structure directing agent. Examples of the substituent include halogens such as fluorine and alkoxy groups.

Examples of a more preferred hydrolyzable silane compound having a silicon atom bonded to a carbon atom of an organic group having one or more carbon numbers include silane compounds represented by the following formula (1):

R¹ₙSi(OR²)₄₋ₙ (1)

(wherein, R¹(s) may be the same or different when there are plural R¹s and each independently represents a linear or branched C₁₋₈ alkyl group which may have a substituent, R²(s) may be the same or different when there are plural R²s and each independently represents a C₁₋₄ alkyl group, and n stands for an integer from 0 to 3).

Specific examples of R¹ include methyl, ethyl, propyl, isopropyl, butyl, isobutyl, sec-butyl, tert-butyl, pentyl, sec-pentyl, neopentyl, hexyl, 2-ethylhexyl, heptyl, octyl, phenyl, o-tolyl, m-tolyl, p-tolyl, xylyl and benzyl groups.

Examples of the silane compound represented by the formula (1) include, but not limited to, methyltrimethoxysilane, methyltriethoxysilane, methyltripropoxysilane, ethyltrimethoxysilane, propyltrimethoxysilane, butyltrimethoxysilane, pentyltrimethoxysilane, hexyltrimethoxysilane, 2-ethylhexyltrimethoxysilane, phenyltrimethoxysilane, dimethyldimethoxysilane, dimethyldiethoxysilane, trimethylmethoxysilane, triethylmethoxysilane and butyldimethylmethoxysilane.

Examples of a tetravalent hydrolyzable silane compound preferably usable for the hydrolysis and condensation include silane compounds represented by the following formula (2):

Si(OR³)₄ (2)

(wherein, R³s may be the same or different and each independently represents a C₁₋₄ alkyl group).

Examples of the silane compound of the formula (2) include, but not limited to, tetramethoxysilane, tetraethoxysilane, tetrapropoxysilane and tetrabutoxysilane.

By mixing the above-described silane compound, followed by hydrolysis and condensation, the physical properties of the film thus available are adjusted. Introduction of hydrocarbon groups in an amount of 5% or greater can accelerate improvement of hydrophobicity of the film thus available and improve the coating properties during spin coating. Addition of the tetravalent hydrolyzable monomer unit such as tetraalkoxysilane is, on the other hand, effective for improving the adhesion of the film to a substrate. Moreover, in the dry gel conversion, in order to efficiently increase the number of micropores by forming a zeolite-like structure in the amorphous portion of the porous low-dielectric-constant precursor film during treatment with water vapor, a tetravalent hydrolyzable monomer is effective. When the tetravalent hydrolyzable monomer amounts to 50 mole % or greater of the monomer used for the condensation of hydrolyzable silane, a micropore increasing effect attributable to zeolite in the resulting film is marked.

The hydrolyzable silane compound is hydrolyzed and condensed into a condensate solution. The silane compound can be prepared using either an acid catalyst or a basic catalyst.

Examples of the acid used as the catalyst for hydrolysis and condensation include inorganic acids such as hydrochloric acid, sulfuric acid and nitric acid, sulfonic acids such as methanesulfonic acid, benzenesulfonic acid, p-toluenesulfonic acid and trifluoromethanesulfonic acid; organic acids such as formic acid, acetic acid, propionic acid, oxalic acid, malonic acid, fumaric acid, maleic acid, tartaric acid, citric acid and malic acid, and phosphoric acid. The acid catalyst may be added in an amount of preferably from 0.001 to 10 times the mass, more preferably from 0.01 to 1 time mass based on the silane compound. Water for hydrolysis may be used in an amount of preferably from 0.1 to 10 times, more preferably from 1.0 to 4.0 times the mole necessary for complete hydrolysis of the silane compound.

The condensate solution can be synthesized also under alkaline conditions. Examples of the base usable for it include amines such as ammonia, ethylamine, propylamine, diisopropylamine, triethylamine and triethanolamine, and alkali metal hydroxides or alkaline earth metal hydroxides such as sodium hydroxide, potassium hydroxide and calcium hydroxide.

The basic catalyst is added in an amount of preferably from 0.001 to 10 times the mass, more preferably from 0.01 to 1 time mass based on the silane compound.

When a mixture of the silane compounds (1) and (2) is hydrolyzed and condensed into a condensate solution, the solution may contain, as well as water, a solvent such as an alcohol corresponding to the alkoxy group of the silane compound. Examples include methanol, ethanol, isopropyl alcohol, butanol, propylene glycol monomethyl ether, propylene glycol monopropyl ether, propylene glycol monopropyl ether acetate, ethyl lactate and cyclohexanone.

The solvent other than water is added in an amount of preferably from 0.1 to 500 times the mass, more preferably from 1 to 100 times the mass based on the mass of the silane compound.

The hydrolysis and condensation reaction of the mixture of the hydrolysable silane compounds (1) and (2) is conducted under conditions employed for ordinary hydrolysis and condensation reaction. The reaction temperature typically falls within a range of from 0° C. to a boiling point of an alcohol generated by the hydrolysis and condensation, preferably from room temperature to 60° C. Although no particular limitation is imposed on the reaction time, it is typically from 10 minutes to 18 hours, more preferably from 30 minutes to approximately 3 hours.

A polymer available by the hydrolysis and condensation of the mixture of the hydrolyzable silane compounds (1) and (2) has a mass-average molecular weight, as determined by gel permeation chromatography (GPC) using polystyrene standards, of preferably from 500 to 50,000,000.

In order to prepare a mixed composition of the above-described silane hydrolysis-condensation product and the material having a zeolite-like recurring portion, they may be mixed after they are prepared respectively or the material having a zeolite-like recurring portion may be added to the reaction system during the hydrolysis and condensation reaction. In the latter case, the condensate may be bonded to the surface of the material having a zeolite-like recurring structure into one body as described below.

The silane hydrolysis-condensation product is not taken out as a single substance but is used as a base solution for preparing a coating composition by subjecting it to solvent exchange from the solvent used for the reaction to a solution by a coating solvent while carrying out treatment such as metal removal by a conventional manner and then concentration under reduced pressure. Methods of it are known by many reports (for example, Japanese Patent Provisional Publication No. 2005-216895)

Next, the material having a zeolite-like recurring portion to be used when the dry gel conversion method is employed will be described.

The material having a zeolite-like recurring portion preferably used in the process of the invention is either a material which is a zeolite-like recurring portion itself (in this case, the material having a silicon oxide portion in an amorphous state has a silicon atom bonded to the carbon atom of an organic group having one or more carbon numbers) or a material having a silicon atom bonded to the carbon atom of an organic group having one or more carbon numbers (in this case, the material having a silicon oxide portion in an amorphous state does not necessarily contain a silicon atom substituted with an organic group).

The material to be used in the former case, that is, a zeolite-like recurring portion itself is available by a known synthesis process, for example, by crystallizing tetrahydroxysilane obtained by the hydrolysis of a tetraalkoxysilane while condensing it in the presence of a structure directing agent. Since an intermediate for synthesizing the material of the latter case having a silicon atom bonded to the carbon atom of an organic group having one or more carbon numbers corresponds to the zeolite-like recurring portion itself so that a concrete description will be made later.

When the zeolite-like recurring portion is used without modification, it may contain giant particles owing to high aggregation activity. In such a case, particles which have become too big may be removed by centrifugal separation or the like prior to use.

When the material of the latter case having a zeolite-like recurring portion is a material having a silicon atom bonded to the carbon atom of an organic group having one or more carbon numbers, it is publicly known, for example, in Japanese Patent Provisional Publication No. 2005-216895 but will be described below.

High-grade zeolite (silicalite) is synthesized by crystallizing tetrahydrofuran obtained by hydrolysis of tetrahalogenated silane, tetraalkoxysilane or silica while condensing it in the presence of a structure directing agent such as tetrapropylammonium hydroxide. Zeolite crystals available, at the time of synthesis, as those having a stable particle size have a particle size of 100 nm or greater. It is difficult to obtain zeolite crystals having a smaller particle size as stable ones. This is presumably because the density of active silanol per unit space of the particle is high. The crystals must be grown to a certain size in order to stabilize the particle size, thereby decreasing a relative density of silanol. Further, they have active silanol on their surface so that even a film-forming composition containing zeolite particles having a particle size of 100 nm or greater may generate precipitates due to adhesion or aggregation of zeolite particles after storage for a long period of time. Thus, they are not completely suited for industrial use.

In order to suppress aggregation of such zeolite particles, it is effective to reduce the density of active silanol on the surface of zeolite. It is possible to stabilize the particle size by modifying the zeolite surface with a silicon atom bonded to the carbon atom of an organic group having one or more carbon numbers (Japanese Patent Provisional Publication No. 2005-216895 and the like). A reduction in the amount of active silanol by such a treatment makes it possible to obtain particles having a fine particle size and a zeolite-like structure. For example, it becomes possible to use, as the material, zeolite seed crystals which have a particle size of 1 nm and are not so large enough to have a long-range structural regularity typical to zeolite, but have regularity of atomic arrangement derived from the zeolite structure. The material having a zeolite-like recurring portion to be used in the invention is a material as described above. When smoothness necessary for use in films of semiconductor devices is required, the particles having a zeolite-like structure have a particle size of preferably 80 nm or less, more preferably 30 nm or less. Such particles do not need planarization treatment later.

Many synthesis processes of a material having a surface modified with a silicon atom bonded to the carbon atom of an organic group having one or more carbon numbers are known and examples of them include the process described in Japanese Patent Provisional Publication No. 2005-216895. The following is one example of these synthesis processes.

With regard to a method for obtaining a zeolite-like recurring portion, which is a key point of the synthesis process, there are many known examples and any of them is usable basically. It is however preferred to use an alkoxysilane compound when the resulting film is used for semiconductor devices, because a material having a trace impurity metal content is available readily. Examples of the preferred raw material include silane compounds represented by the following formula (3):

Si(OR₄)₄ (3)

(wherein, R⁴s may be the same or different and each independently represents a linear or branched C₁₋₄ alkyl group).

Specific examples of the compound include, but not limited to, tetramethoxysilane, tetraethoxysilane, tetrapropoxysilane, tetrabutoxysilane, tetraisopropoxysilane, tetraisobutoxysilane, triethoxymethoxysilane, tripropoxymethoxysilane, tributoxymethoxysilane, trimethoxyethoxysilane, trimethoxypropoxysilane, and trimethoxybutoxysilane.

According to the process of the invention, the silane compounds may be used either singly or in combination.

Many of structure directing agents to be used for the synthesis of zeolite or the zeolite-like recurring portion are publicly known. Most preferred examples include quaternary organic ammonium hydroxides represented by the following formula (4):

R⁵₄N⁺X⁻ (4)

(wherein, R⁵s may be the same or different and each independently represents a linear or branched C₁₋₆ alkyl group and X is OH, halogen, OAc or NO₃).

Specific examples of R⁵ include methyl, ethyl, propyl and butyl groups. Especially preferred examples of such a structure directing agent include, but not limited to, tetramethylammonium hydroxide, tetraethylammonium hydroxide, tetrapropylammonium hydroxide, tetrabutylammonium hydroxide, triethylmethylammonium hydroxide, tripropylmethylammonium hydroxide and tributylmethylammonium hydroxide.

In the preparation process of the material having a zeolite-like recurring portion, the structure directing agent is used as a mixture with the silane compound. The structure directing agent is added in an amount of preferably from 0.1 to 20 moles, more preferably from 0.5 to 10 moles per mole of the silane compound represented by the formula (3).

In order to perform crystallization while carrying out hydrolysis and condensation of the compound represented by the formula (3) to obtain the zeolite-like recurring portion, a basic catalyst is necessary in addition to the structure directing agent. When the compound represented by the formula (4) in which X⁻ is a hydroxy ion is used as the structure directing agent, the structure directing agent itself may be allowed to function as a basic catalyst. Another basic catalyst may be added further.

As the another basic catalyst to be added further, preferred are compounds represented by the following formula (5):

(R⁶)₃N (5)

(wherein, R⁶s may be the same or different and each independently represents a hydrogen atom or a linear, branched or cyclic C₁₋₂₀ alkyl or aryl group, with the proviso that the hydrogen atom contained in the alkyl or aryl group may be substituted with a hydroxy or amino group) and compounds represented by the following formula (6):

(R⁷)ₘX (3)

(wherein, R⁷s may be the same or different and each independently represents a hydrogen atom or a linear, branched or cyclic C₁₋₂₀ alkyl or aryl groups, with the proviso that the hydrogen atom contained in the alkyl or aryl group may be substituted with a hydroxy or nitrogen-containing group; when m stands for an integer of 2 or greater, two R⁷s may be coupled to each other to form a ring; m stands for an integer from 0 to 3; and X represents a m-valent heterocyclic compound containing a nitrogen atom).

Examples of R⁶ include, but not limited to, hydrogen atom, and methyl, ethyl, propyl, isopropyl, butyl, isobutyl, pentyl, hexyl, heptyl, octyl, decyl, dodecyl, octadecyl, cyclohexyl, phenyl and tolyl groups.

Examples of the basic catalyst represented by the formula (5) include ammonia, methylamine, ethylamine, propylamine, butylamine, pentylamine, dodecylamine, octadecylamine, isopropylamine, t-butylamine, ethylenediamine, 1,2-diaminopropane, 1,3-diaminopropane, hexamethylenediamine, dimethylamine, diethylamine, dipropylamine, diisopropylamine, dibutylamine, trimethylamine, triethylamine, tripropylamine, tributylamine, N,N-dimethyloctylamine, triethanolamine, cyclohexylamine, aniline, N-methylaniline, diphenylamine and toluidines.

Examples of R⁷ include hydrogen atom and methyl, ethyl, propyl, isopropyl, butyl, isobutyl, pentyl, hexyl, heptyl, octyl, decyl, dodecyl, octadecyl, cyclohexyl, phenyl, tolyl, amino, methylamino, ethylamino, propylamino, butylamino, pentylamino, dodecylamino, octadecylamino, isopropylamino, tert-butylamino, dimethylamino, diethylamino, dipropylamino, diisopropylamino, dibutylamino, N,N-dimethyloctylamino, cyclohexylamino, and diphenylamino groups.

Examples of X include, but not limited to, pyrrolidine, piperidine, morpholine, pyridine, pyridazine, pyrimidine, pyrazine and triazine.

Examples of the basic catalyst represented by the formula (6) include, but not limited to, DBU, DBN, pyrrolidine, piperidine, morpholine, pyridine, picolines, phenylpyridines, N,N-dimethylaminopyridine, pyridazine, pyrimidine, pyrazine, and triazine.

Especially preferred examples of the basic catalyst to be used in the process of the invention include TMAH (tetramethylammonium hydroxide), ammonia, methylamine, ethylamine, propylamine, isopropylamine, pyrrolidine, piperidine, morpholine, pyridine, DBU and DBN.

In the process of the invention, basic catalysts may be used either singly or in combination.

Such a basic catalyst is mixed with, for example, the silane compound represented by the formula (3) and the structure directing agent represented by the formula (4). The amount of the basic catalyst is preferably from 0.01 to 20 moles, more preferably from 0.05 to 10 moles per mole of the silane compound represented by the formula (3).

When zeolite fine crystals are prepared by hydrolysis and condensation polymerization of the silane compound of the formula (3), water necessary for hydrolysis is added as well as the silane compound, structure directing agent and basic catalyst. Water is added in an amount of preferably from 0.1 to 100 times the mass, more preferably from 0.5 to 20 times the mass based on the mass of the silane compound.

In this reaction, a solvent other than water such as alcohol can be added. Examples include methanol, ethanol, isopropyl alcohol, butanol, propylene glycol monomethyl ether, propylene glycol monopropyl ether, propylene glycol monopropyl ether acetate, ethyl lactate and cyclohexanone. The solvent may be added in an amount of preferably from 0.1 to 100 times the mass, more preferably form 0.5 to 20 times the mass based on the mass of the silane compound.

The hydrolysis time is preferably from 1 to 100 hours, more preferably from 10 to 70 hours, while the temperature is preferably from 0 to 50° C., more preferably form 15 to 30° C. The heat treatment after the hydrolysis is performed at a temperature of preferably 30° C. or greater, more preferably 50° C. or greater but not greater than 80° C. for preferably from 1 to 100 hours, more preferably from 10 to 70 hours. Heat treatment temperature of 100° C. greater allows mixing of considerably large zeolite crystals.

Since the zeolite-like recurring portion thus obtained has very high aggregation activity, isolation of it is therefore not preferred. When the zeolite-like recurring portion is formed by the above-described reaction and it is grown to be a desired size, the hydrolyzable silane compound substituted with an organic group having one or more carbon numbers bonded to a silicon atom is added in the form of a dispersion and modify the surface.

As described above, when a composition is prepared using, in combination, the silicon oxide polymer having a silicon atom bonded to the carbon atom of an organic group having one or more carbon numbers and the zeolite-like recurring portion itself, the zeolite-like recurring portion obtained above and not surface modified can be used.

The organic group may be a substituted or unsubstituted hydrocarbon. Examples of it include aliphatic hydrocarbon groups, aromatic hydrocarbon groups, aliphatic hydrocarbon groups substituted with an aromatic hydrocarbon group, and aromatic hydrocarbon groups substituted with an aliphatic hydrocarbon. They may contain a hetero-atom-containing substituent insofar as it is not a substituent, such as carboxyl group, having a strong interaction with the structure directing agent. Examples of the substituent include halogens such as fluorine and alkoxy groups.

Examples of a more preferred hydrolyzable silane compound having a silicon atom bonded to the carbon atom of an organic group having one or more carbon numbers include compounds represented by the following formula (7):

R⁸ₙSi(OR⁹)₄₋ₙ (7)

(wherein, R⁸(s) may be the same or different and each independently represents a linear, cyclic or branched C₁₋₆ alkyl or aryl group, some hydrogen atoms of which may be substituted with a fluorine atom, R⁹(s) may be the same or different and each independently represents a linear or branched C₁₋₄ alkyl group, and n stands for an integer from 0 to 3).

In the formula (7), specific examples of R⁸, when it represents a linear or branched C₁₋₆ alkyl or aryl group, include methyl group, ethyl group, propyl group, isopropyl group, butyl group, isobutyl group, sec-butyl group, tert-butyl group, pentyl group, sec-pentyl group, neopentyl group, hexyl group, and phenyl group.

At the same time, the tetravalent hydrolyzable silane compound represented by the formula (3) may be added.

The modification reaction as described above can be carried out in a known manner as disclosed in Japanese Patent Provisional Publication No. 2005-216895, but principally modification can be carried out by adding, after synthesis of zeolite, the hydrolyzable silane compound of the formula (7) to the reaction mixture.

A material having a zeolite-like recurring portion which is greatly stabilized, has aggregation activity strongly suppressed, and is modified by a silicon atom bonded to the carbon atom of an organic group having one or more carbon numbers is available by adding, for the modification reaction, the hydrolyzable silane compound of the formula (7) substituted with the organic group having one or more carbon numbers for bonding to a silicon atom and preferably carrying out maturing at a reaction temperature of 85° C. or greater. Together with the hydrolyzable silane compound of the formula (7), the tetravalent hydrolyzable silane compound of the formula (3) may be added further. The hydrolyzable silane compound of the formula (7) is added in an amount of desirably 0.01 (mole/mole) or greater, adequately 1.0 (mole/mole) or less relative to the total mole of the silicon atoms other than the silicon atom of the hydrolyzable silane compound of the formula (7). When the amount is 2 (mole/mole) or greater, the resulting material is not greatly stabilized but rather shows characteristics of a material having a zeolite-like recurring portion modified with the above-described conventional side chain.

The present inventors presume that since the high stability of the material having a zeolite-like recurring portion modified with a silicon atom substituted with an organic group and obtained by maturing at a reaction temperature of 85° C. or greater is utterly different, as described below, from that of the material obtained by surface modification without raising the reaction temperature, such an effect is not simple modification produced but it is produced because the silicon atom substituted with an organic group is incorporated in the recurring portion of silicon oxide constituting the zeolite crystal structure having regularity. Particularly, the zeolite-like recurring portion not containing particles having a giant particle size is available by controlling the temperature at 80° C. or less, more preferably at 75° C. or less. The material obtained by adding the hydrolyzable silane compound of the formula (7) to a synthesis reaction mixture of the zeolite-like recurring portion containing zeolite fine particles having an average particle size of 80 nm or less, especially 10 nm or less, more preferably 5 nm or less and subjecting the resulting mixture to a maturing reaction at a high temperature contains few zeolite fine particles having a giant particle size even after completion of the reaction. Therefore, zeolite fine particles obtained by preparing zeolite fine particles having a particle size of 5 nm or less at 75° C. or less, adding thereto the hydrolyzable silane compound of the formula (7) and subjecting the mixture to a maturing reaction at 85° C. or greater can be filtered through a filter having a pore size of 0.2 μm without using particular means for separating fine particles of another particle size even if the particles are grown to a particle size of, for example, approximately 120 nm by the maturing reaction. Such stability against aggregation cannot be accomplished by the method disclosed in Japanese Patent Provisional Publication No. 2005-216895 or the like.

Even when a zeolite derivative having a surface activity suppressed by bonding thereto of a silicon atom bonded to the carbon atom of an organic group having one or more carbon numbers is used as the material having a zeolite-like recurring portion, a zeolite-containing film having increased micropores can be formed by using silica as a material having a silicon oxide portion in an amorphous state or further a silicon oxide polymer containing a silicon atom bonded to the carbon atom of an organic group having one or more carbon numbers in the below-described combination and subjecting the mixture to a dry gel conversion method. Moreover, activity as zeolite seed crystals to be used for the dry gel conversion method of the invention can be obtained also by zeolite fine particles subjected to an operation which is presumed to incorporate a silicon atom bonded to the carbon atom of an organic group having one or more carbon numbers in the recurring structure of zeolite crystals by carrying out the above-described high-temperature maturing reaction. By using the dry gel conversion method, the zeolite structure in the film can be grown. What is interesting is that when zeolite fine particles containing a silicon atom bonded to the carbon atom of an organic group having one or more carbon numbers are used as zeolite seed crystals, the zeolite particles in the film available after dry gel conversion are likely to be free from particles having an extraordinarily increased particle size. Particularly a film available from the zeolite fine particles subjected to the above-described high temperature maturing reaction does not require CMP treatment when used in the manufacture of semiconductor devices having a minute structure.

The material having a zeolite-like recurring portion obtained above is not taken out as a single substance but is used as a base solution for preparing a coating composition by subjecting it to solvent exchange from the solvent used for the reaction to a solution by a coating solvent while carrying out treatment such as metal removal by a conventional manner and then concentration under reduced pressure. Methods of it are known by many reports (for example, Japanese Patent Provisional Publication No. 2005-216895).

When in a film-forming composition to be used for forming a precursor film to be subjected to the dry gel conversion method of the invention, the material having a zeolite-like recurring portion and the material having a silicon oxide portion in an amorphous state are used in the following combination when they are different materials. They are a combination of the material having a zeolite-like recurring unit substituted with an organic group and an amorphous silica, that of a silicon oxide polymer containing a silicon atom substituted with an organic group as the material having a silicon oxide portion in an amorphous state and zeolite fine particles, and that of the material having a zeolite-like recurring portion substituted with an organic group and, as the material having a silicon oxide portion in an amorphous state, a silicon oxide polymer containing a silicon unit substituted with an organic group. Such a combination is dissolved in a coating solvent and provided as a coating solution.

No particular limitation is imposed on the mixing ratio of the material having a zeolite-like recurring portion and the material having a silicon oxide portion in an amorphous state. When the material having a silicon oxide portion in an amorphous state contains a large amount of a component derived from a tetraalkoxysilane which will act as a tetravalent silane at the time of hydrolysis, the dry gel conversion method facilitates the growth of a zeolite-like crystal portion, leading to improvement of mechanical strength and dielectric properties even if an amount of zeolite fine crystals is small. When the material contains a large amount of a component having an organic group, on the other hand, definite effects are produced when the amount of the material having a zeolite-like recurring portion which will be a nucleus of crystal growth is larger. In general, the number of effective micropores can be increased easily when the material having a zeolite-like recurring portion is added in an amount of 0.5 or greater relative to the mass of the material having a silicon oxide portion in an amorphous state.

Although the material having a zeolite-like recurring portion has improved stability by bonding thereto a silicon unit substituted with an organic group, aggregation activity cannot be completely suppressed and it is therefore impossible to weigh its dry mass and then re-disperse it in a solvent. An amount of the material having a zeolite-like recurring portion to be added is therefore determined based on the mass of the material having a zeolite-like recurring portion contained in a portion sampled from a dispersion of the material having a zeolite-like recurring portion which has been made uniform.

Two or more materials having a zeolite-like recurring portion which are different in average particle size may be used in combination as needed. They can be mixed at any ratio, depending on the physical properties of the materials having a zeolite-like recurring portion or physical properties of an intended porous film.

Further, in the composition for forming a precursor film of a porous low-dielectric-constant film, a stabilizer for preventing aggregation of the material having a zeolite-like recurring portion in the composition or quality deterioration of a silane compound condensate and a surfactant for improving coating properties may be incorporated.

In the coated film, the material providing a zeolite recurring portion and the material providing a silicon oxide portion in an amorphous state are not necessarily present as separate materials, but may be integrated in one molecule.

The material obtained by reacting the above-described zeolite-like recurring portion with the hydrolyzable silane compound having a silicon atom bonded to the carbon atom of an organic group having one or more carbon numbers or with a mixture of the compound has, in the molecule, the zeolite-like recurring portion and the silicon oxide portion in an amorphous state. A zeolite-containing film having increased micropores can be formed by preparing a composition containing the above-described material but not containing a silicon oxide polymer, forming a coated film, and subjecting the film to the dry gel conversion method.

What is interesting is that the material obtained by adding the hydrolyzable silane substituted with an organic group or mixture thereof to the zeolite-like recurring portion and then preferably carrying our maturing at a reaction temperature of 85° C. or greater has strongly suppressed aggregation activity as described above. The structure of the particle surface is presumed to undergo a drastic change, but this material may be accompanied with the silicon oxide portion in an amorphous state. After formation of a coated film using a composition containing the material but no silicon oxide polymer, followed by dry gel conversion method, an apparent increase in the number of micropores can be confirmed.

Use of a composition, as a film-forming composition, containing not a silicon oxide polymer but only inorganic zeolite fine particles may cause problems in coating properties or adhesion or cause generation of cracks. Not only the material containing silicon substituted with an organic group, that is, the material obtained by reacting the zeolite recurring portion with the hydrolyzable silane compound having a silicon atom bonded to the carbon atom of an organic group having one or more carbon numbers or mixture of the compound but also the material obtained by adding the hydrolyzable silane substituted with an organic group to the zeolite seed crystals and preferably maturing the mixture at a reaction temperature of 85° C. or greater can prevent such problems.

It becomes possible to form a thin film having any film thickness by preparing a porous film-forming composition, controlling the solute concentration thereof and then spin-coating it at an adequate rotation number. The thin film having, as an actual thickness, a thickness of from 0.2 to 1.0 μm is typically formed, but the film thickness is not limited thereto. A thin film having a greater film thickness can be formed, for example, by spin coating a plurality of times.

The coating method is not limited to spin coating and another method such as scan coating can also be employed.

Examples of the solvent used for dilution include aliphatic hydrocarbon solvents such as n-pentane, isopentane, n-hexane, isohexane, n-heptane, 2,2,2-trimethylpentane, n-octane, isooctane, cyclohexane and methylcyclohexane; aromatic hydrocarbon solvents such as benzene, toluene, xylene, ethylbenzene, trimethylbenzene, methylethylbenzene, n-propylbenzene, isopropylbenzene, diethylbenzene, isobutylbenzene, triethylbenzene, diisopropylbenzene and n-amylnaphthalene; ketone solvents such as acetone, methyl ethyl ketone, methyl n-propyl ketone, methyl n-butyl ketone, methyl isobutyl ketone, cyclohexanone, 2-hexanone, methylcyclohexanone, 2,4-pentanedione, acetonylacetone, diacetone alcohol, acetophenone, and fenthion; ether solvents such as ethyl ether, isopropyl ether, n-butyl ether, n-hexyl ether, 2-ethylhexyl ether, dioxolane, 4-methyldioxo lane, dioxane, dimethyldioxane, ethylene glycol mono-n-butyl ether, ethylene glycol mono-n-hexyl ether, ethylene glycol monophenyl ether, ethylene glycol mono-2-ethylbutyl ether, ethylene glycol dibutyl ether, diethylene glycol monomethyl ether, diethylene glycol dimethyl ether, diethylene glycol monoethyl ether, diethylene glycol diethyl ether, diethylene glycol monopropyl ether, diethylene glycol dipropyl ether, diethylene glycol monobutyl ether, diethylene glycol dibutyl ether, tetrahydrofuran, 2-methyltetrahydrofuran, propylene glycol monomethyl ether, propylene glycol dimethyl ether, propylene glycol monoethyl ether, propylene glycol diethyl ether, propylene glycol monopropyl ether, propylene glycol dipropyl ether, propylene glycol monobutyl ether, dipropylene glycol dimethyl ether, dipropylene glycol diethyl ether, dipropylene glycol dipropyl ether and dipropylene glycol dibutyl ether, ester solvents such as diethyl carbonate, ethyl acetate, γ-butyrolactone, γ-valerolactone, n-propyl acetate, isopropyl acetate, n-butyl acetate, isobutyl acetate, sec-butyl acetate, n-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, dipropylene glycol monomethyl ether acetate, dipropylene glycol monoethyl ether acetate, dipropylene glycol mono-n-butyl ether acetate, glycol diacetate, methoxytriglycol acetate, ethyl propionate, n-butyl propionate, isoamyl propionate, diethyl oxalate, di-n-butyl oxalate, methyl lactate, ethyl lactate, n-butyl lactate, n-amyl lactate, diethyl malonate, dimethyl phthalate and diethyl phthalate; nitrogen-containing solvents such as N-methylformamide, N,N-dimethylformamide, acetamide, N-methylacetamide, N,N-dimethylacetamide, N-methylpropionamide, and N-methylpyrrolidone, and sulfur-containing solvents such as dimethyl sulfide, diethyl sulfide, thiophene, tetrahydrothiophene, dimethyl sulfoxide, sulfolane, and 1,3-propanesultone. These solvents may be used either singly or in combination.

The dilution degree differs depending on the viscosity or intended film thickness, but the solvent is usually added to give a concentration of from 50 to 99 mass %, more preferably from 75 to 95 mass %.

The thin film formed in such a manner is then heated preferably at from 50 to 150° C. for several minutes in a drying step (which is a step typically called “presintering” in a semiconductor process) to remove the solvent.

The thin film containing zeolite fine particles thus obtained is then subjected to the dry gel conversion method. Many dry gel conversion methods are already known and no special requirements are necessary in performing them in the invention.

Water vapor treatment of the dry gel conversion method can be carried out by any known manner, but is typically conducted by placing a substrate having the film formed thereon and a small amount of water in a pressure-resistant airtight container in such a manner as to avoid direct contact of the substrate itself with water and heating to 50 to 200° C. under a hermetically sealed condition to bring water vapor into contact with the film for 0.5 to 100 hours, preferably for 6 to 50 hours, more preferably for 12 to 30 hours. When the zeolite-like recurring portion in the film contains a sufficient amount of the quaternary ammonium salt used during synthesis, treatment only with water vapor can enhance the growth of zeolite crystals. The growth can however be enhanced by incorporating ammonia or organic amine in the atmosphere. Examples of the amine include triethylamine, ethylenediamine, trimethylamine, methyl piperidine, N-methylpiperidine, pyrrolidine, choline, and triethanolamine. The atmosphere may contain an alcohol or the like.

The zeolite-containing film obtained by the dry gel conversion method is suited for use as a porous low-dielectric-constant dielectric film in semiconductor devices because hydrophilicity on the film surface can be controlled readily by an organic group containing a carbon atom to be bonded to the silicon atom. Moreover, a smooth film can be obtained by using, as a material capable of providing a zeolite-like recurring portion, that having surface activity controlled by substitution with an organic group so that such a film can be used in semiconductor devices without treatment such as CMP. The effect of providing a smooth film is especially high when a hydrolyzable silane compound substituted with an organic group or a mixture of the compound is added to the zeolite-like recurring portion and the resulting mixture is preferably matured at a reaction temperature of 85° C. or greater.

When the thin film thus formed is used as a porous low-dielectric-constant dielectric film in semiconductor devices, it can be sintered in a known manner into a low-dielectric-constant dielectric film. Described specifically, a porous film can be obtained finally by sintering the substrate subjected to the dry gel conversion treatment typically at from 350° C. to 500° C. for from approximately 5 minutes to 2 hours.

After the dry gel conversion treatment, it is possible to add an additional step such as curing by exposure to high energy radiation such as ultraviolet rays, electron beams and then, perform the above-described sintering step. Alternatively, the film subjected to the dry gel conversion treatment may be sintered, followed by treatment with ultraviolet rays, electron beams or the like.

One embodiment of the semiconductor device of the invention will next be described.

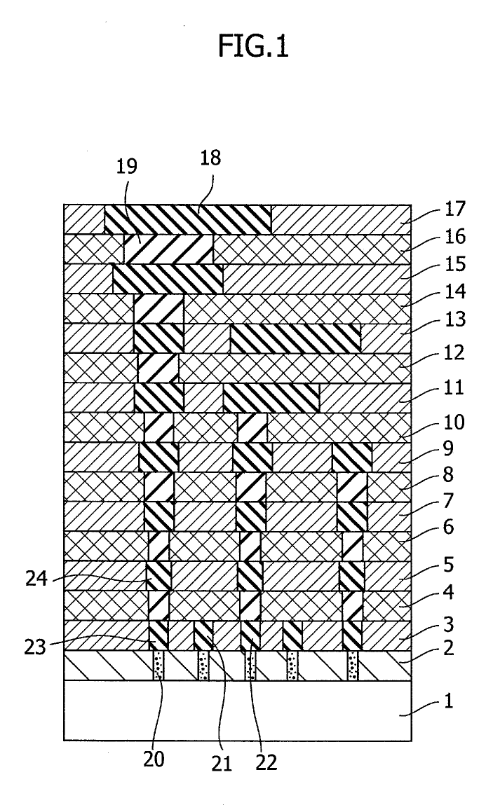

FIG. 1 is a schematic cross-sectional view illustrating one example of the semiconductor device of the invention.

In FIG. 1, as substrate 1, Si semiconductor substrates such as Si substrate and SOI (Si On Insulator) substrate can be employed. Alternatively, it may be a compound semiconductor substrate such as SiGe or GaAs.

As interlayer dielectric films, interlayer dielectric film 2 of a contact layer, interlayer dielectric films 3, 5, 7, 9, 11, 13, 15, and 17 of interconnect layers, and interlayer dielectric films 4, 6, 8, 10, 12, 14, and 16 of a via layer are illustrated.

The interconnect layers from the interlayer dielectric film 3 of the bottom interconnect layer to the interlayer dielectric film 17 of the uppermost interconnect layer are abbreviated as M1, M2, M3, M4, M5, M6, M7 and M8, respectively in the order from the bottom to the top. The via layers from the interlayer dielectric film 4 of the bottom via layer to the interlayer dielectric film 16 of the uppermost via layer are abbreviated as V1, V2, V3, V4, V5, V6 and V7, respectively in the order from the bottom to the top.

Some metal interconnects are indicated by numerals 18 and 21 to 24, respectively, but even if such a numeral is omitted, portions with the same pattern as that of these metal interconnects are metal interconnects.

A via plug 19 is made of a metal and it is typically copper in the case of a copper interconnect. Even if a numeral is omitted, portions with the same pattern as that of these via plugs are via plugs.

A contact plug 20 is connected to a gate of a transistor (not illustrated) formed on the uppermost surface of the substrate 1 or to the substrate. Thus, the interconnect layers and via layers are stacked one after another. The term “multilevel interconnects” typically means M1 and layers thereabove.

The interconnect layers M1 to M3 are typically called local interconnects; the interconnect layers M4 to M5 are typically called intermediate or semi-global interconnects; and the interconnect layers M6 to M8 are typically called global interconnects.

In the semiconductor device of the invention, the porous film of the invention is used as at least one of the interlayer dielectric films 3, 5, 7, 9, 11, 13, 15, and 17 of the interconnect layers and the interlayer dielectric films 4, 6, 8, 10, 12, 14 and 16 of the via layers.

For example, when the porous film of the invention is used as the interlayer dielectric film 3 of the interconnect layer (M1), a capacitance between the metal interconnect 21 and metal interconnect 22 can be reduced greatly.

When the porous film of the invention is used as the interlayer dielectric film 4 of the via layer (V1), a capacitance between the metal interconnect 23 and metal interconnect 24 can be reduced greatly.

Thus, use of the porous film of the invention having a low dielectric constant for the interconnect layer enables a drastic reduction of the capacitance between metal connects in the same layer.

In addition, use of the porous film of the invention having a low dielectric constant for the via layer enables a drastic reduction in the capacitance between the metal interconnects above and below the via layer.

Accordingly, use of the porous film of the invention for all the interconnect layers and via layers enables a great reduction in the parasitic capacitance of interconnects.

In addition, when the porous film of the invention is used as a dielectric film for interconnection, by controlling the physical properties of the porous film, it is possible to suppress an increase in a dielectric constant due to moisture absorption of the porous film.

As a result, the semiconductor device which can be operated at a high speed and low power consumption can be obtained.

The porous film of the invention has strong mechanical strength so that it contributes to an improvement in the mechanical strength of a semiconductor device. As a result, the semiconductor device using it can be manufactured in a higher production yield and have greatly improved reliability.

### EXAMPLES

The invention will hereinafter be described in detail by Examples and Comparative Examples. It should however be borne in mind that the invention is not limited to or by them.

### Preparation Process 1

### Synthesis of a Material Having a Zeolite-Like Recurring Portion

Tetraethoxysilane (208.4 g) and 474.6 g of a 15% tetrapropylammonium hydroxide solution were mixed and the resulting mixture was stirred at room temperature for 3 days. The reaction mixture was then heated under reflux for 10 hours, whereby an aqueous solution containing a zeolite-like recurring portion was obtained. The particle size distribution of the zeolite seed crystals thus obtained was 0.9 nm as a result of measurement using a “Nanotrac Particle Analyzer UPA-EX 150” (trade name; product of Nikkiso).

### Production Example 2

### Synthesis of a Material Having a Zeolite-Like Recurring Portion Substituted With an Organic Group and Stabilized by Maturing at a Reaction Temperature of 85° C. or Greater

Tetraethoxysilane (5 g) and 8.55 g of methyltriethoxysilane were added to 50 g of the aqueous solution containing a zeolite-like recurring portion obtained in Production Example 1. The resulting mixture was reacted at 85° C. for 24 hours in an airtight container to obtain an aqueous solution of the material containing a zeolite-like recurring portion substituted with an organic group and stabilized by maturing at a reaction temperature of 85° C. or greater.

To the aqueous solution of the material was added 80 g of propylene glycol propyl ether and ethanol and water were distilled off under reduced pressure, whereby a solution of zeolite fine crystals in propylene glycol propyl ether was obtained. The particle size of the resulting material having a zeolite-like recurring portion substituted with an organic group was measured as in Production Example 1. The peak of the particle size was 20 nm.

The solution thus obtained was diluted, followed by filtration through a 0.2 μm filter to prepare a zeolite-film-forming coating solution.

### Production Example 3

### Synthesis of a Material Having a Zeolite-Like Recurring Portion Substituted With an Organic Group

To 50 g of the aqueous solution containing a zeolite-like recurring portion obtained in Production Example 1 were added 5 g of tetraethoxysilane and 8.55 g of methyltriethoxysilane. The resulting mixture was reacted at 80° C. for 24 hours in a nitrogen gas stream, whereby an aqueous solution of a material having a zeolite-like recurring portion substituted with an organic group was obtained.

To the aqueous solution of the material was added 80 g of propylene glycol propyl ether. Ethanol and water were distilled off under reduced pressure, whereby a solution of zeolite fine particles in propylene glycol propyl ether was obtained. As a result of measurement of the particle size of the resulting material having a zeolite-like recurring portion as in Production Example 1, the peak of the particle size was 85 nm.

The solution thus obtained was not filtered through a 0.2-μm filter so that it was diluted as was to prepare a zeolite-film-forming coating solution.

### Production Example 4

### Preparation of a Silicon Oxide Polymer in an Amorphous State

To 300 g of water containing 5 g of a 25% aqueous ammonia solution was added 40 g of tetraethoxysilane and the mixture was reacted at 60° C. for 3 hours to prepare an aqueous solution of silica in an amorphous state.

To the aqueous solution of the material was added 80 g of propylene glycol propyl ether. Water was distilled off under reduced pressure, whereby a solution of silica in propylene glycol propyl ether was obtained.

### Preparation Example 4

### Preparation of an Organic-Group-Substituted Silicon Oxide Polymer in an Amorphous State

To 300 g of water containing 5 g of a 25% aqueous ammonia solution was added 600 g of ethanol, followed by the addition of 20 g of tetraethoxysilane and 7.5 g of methyltrimethoxysilane. The resulting mixture was reacted at 60° C. for 3 hours to prepare an aqueous solution of silica in an amorphous state.

To the aqueous solution of the material was added 80 g of propylene glycol propyl ether. Water was distilled off under reduced pressure, whereby a solution of silica in propylene glycol propyl ether was obtained.

The materials prepared in the above examples were mixed in accordance with Table 1 to prepare a base solution of a film-forming composition. When each of the mixtures was spin-coated at 1500 rpm, the concentration was adjusted with propylene glycol propyl ether so that the film thickness would be 300 nm.

Then, each composition was spin coated on a 4-inch silicon wafer for test, followed by presintering at 150° C. for 2 minutes to remove the solvent by drying, whereby a test piece was obtained.

Of the films thus obtained, the film obtained in Comparative Composition Example 2 was turbid and partially cracked.

TABLE 1

| | Prep- | Prep- | Prep- | Prep- | Prep- |
|---|---|---|---|---|---|
| | aration | aration | aration | aration | aration |
| | Example 1 | Example 2 | Example 3 | Example 4 | Example 5 |
| Composition | | 1 | | 2 | |
| Example 1 | | | | | |
| Composition | | 1 | | | 2 |
| Example 2 | | | | | |
| Composition | | | 1 | 2 | |
| Example 3 | | | | | |
| Composition | | | 1 | | 2 |
| Example 4 | | | | | |
| Composition | 1 | | | | 2 |
| Example 5 | | | | | |
| Composition | | 1 | | | |
| Example 6 | | | | | |
| Comparative | 1 | | | 1 | |
| Composition | | | | | |
| Example 1 | | | | | |
| Comparative | 1 | | | | |
| Composition | | | | | |
| Example 2 | | | | | |

(The above-described value indicates a dry weight ratio of the material prepared in each preparation example.)

### Examples 1 to 6 and Comparative Example 1 and 2

Test pieces obtained by forming films using the compositions obtained in Composition Examples 1 to 6 and Comparative Composition Examples 1 and 2 were each placed in a 2-L autoclave so as to avoid immersion of it in 200 ml of water also placed therein. It was heated while opening a pressure reducing valve. The pressure reducing valve was closed when water vapor was released sufficiently therefrom. It was heated at a temperature maintained 100° C. and dry gel conversion was performed for 24 hours. Then it was sintered at 500° C. for 1 hour, whereby a zeolite-containing film was obtained. The film was treated as needed with hexamethyldisilazane vapor (HMDS treatment) and provided for the following measurements.

The appearance of the zeolite film thus obtained was observed through a scanning electron microscope and the test pieces having a very smooth appearance, a smooth appearance, a surface roughness, and a severe surface roughness were ranked A, B, C and D, respectively. Observation results of the film obtained in Examples 1 to 6 and Comparative Examples 1 and 2 are shown in Table 2.

A micropore content was determined by a proportion of a nitrogen gas adsorption amount (P/P₀<1, 0E⁻⁴) of a micropore region in a nitrogen adsorption amount (P/P₀<0.5) of a region of mesopores or greater pores, as measured by the nitrogen adsorption method by “Autosorb-1” manufactured by Quantachrome Instruments.

A k value as a low-dielectric-constant property and Modulus as film strength were measured using “495CV system” (mercury probe) product of Solid State Measurement Inc. and “Nano Indenter SA2”, product of MTS, respectively. The results are shown in Table 2.

### Comparative Examples 3 to 8

The test pieces obtained by film formation using the compositions obtained in Composition Examples 1 to 6 were each sintered at 500° C. for 1 hour to obtain zeolite-containing films.

Appearance, k value and Modulus of each of the films thus obtained were measured as in Examples 1 to 6. The results are shown in Table 2.

TABLE 2

| | | Micropore | | | |
|---|---|---|---|---|---|
| | | content | Modulus | Value | |
| | Appearance | (%) | (GPa) | k | HMDS |
| Ex. 1 | A | 25% | 20 | 2.8 | Treated |
| Ex. 2 | A | 22% | 19 | 2.7 | Not treated |
| Ex. 3 | B | 25% | 20 | 2.8 | Treated |
| Ex. 4 | B | 22% | 19 | 2.7 | Not treated |
| Ex. 5 | A | 22% | 19 | 2.7 | Not treated |
| Ex. 6 | A | 24% | 19 | 2.7 | Treated |
| Comp. Ex. 1 | B | 30% | 12 | 2.9 | Treated |
| Comp. Ex. 2 | B | 35% | 12 | 2.9 | Treated |
| Comp. Ex. 3 | A | 5% | 8 | 2.9 | Treated |
| Comp. Ex. 4 | A | 5% | 8 | 2.5 | Not treated |
| Comp. Ex. 5 | A | 7% | 8 | 2.9 | Treated |
| Comp. Ex. 6 | A | 7% | 8 | 2.5 | Not treated |
| Comp. Ex. 7 | A | 6% | 8 | 2.5 | Not treated |
| Comp. Ex. 8 | A | 6% | 8 | 2.7 | Not treated |

It has been confirmed from the comparison with the micropore content of the films obtained in Comparative Examples 3 to 8 that use of the dry gel conversion method enables growth of a zeolite structure in the film in the case where the material having a zeolite-like recurring portion which will be zeolite seed crystals at the time of dry gel conversion contains a silicon atom bonded to the carbon atom of an organic group having one or more carbon numbers; the material having an amorphous silicon oxide portion which is a supply source of silicon oxide for zeolite growth contains a silicon atom bonded to the carbon atom of an organic group having one or more carbon numbers; or these materials both contains a silicon atom bonded to the carbon atom of an organic group having one or more carbon numbers.

In addition, it has been confirmed that the physical properties of the film having a zeolite structure grown therein are controlled by the organic substituent and an increase in dielectric constant due to drastic moisture absorption as in Comparative Example 1 is suppressed.

The films of Examples 1 to 4 obtained using a zeolite-like recurring portion having an organic substituent were free from growth of large zeolite grain aggregates due to zeolite growth as was observed from Comparative Example 1, and they were smooth and contained a grown zeolite structure.

In Example 6, a particularly smooth film as described above was obtained and this film was free from film formation abnormalities observed in Comparative Example 2 such as turbidity and peeling.

Many modifications and other embodiments of the inventions set forth herein will come to mind to one skilled in the art to which these inventions pertain having the benefit of the teachings presented in the foregoing description. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process for preparing a zeolite-containing film, comprising the steps of:
preparing a film-forming composition which contains a first material having a silicon oxide portion in an amorphous state and a second material having a zeolite-like recurring portion;
applying the film-forming composition onto a substrate to form a precursor film containing the silicon oxide portion in an amorphous state and the zeolite-like recurring portion; and
heat treating the precursor film in the presence of water vapor by dry gel conversion method to grow the zeolite-like recurring portion;
wherein the first material and/or the second material contain(s) a silicon atom bonded to a carbon atom of an organic group having one or more carbon numbers.

2. The process according to claim 1, wherein the organic group is a substituted or unsubstituted hydrocarbon group.

3. The process according to claim 1, wherein the second material has the zeolite-like recurring portion and the silicon atom bonded to a carbon atom of an organic group having one or more carbon numbers.

4. The process according to claim 1, wherein the first material is a silicon oxide polymer containing the silicon atom bonded to a carbon atom of an organic group having one or more carbon numbers.

5. The process according to claim 1, wherein the second material has the zeolite-like recurring portion and the silicon atom bonded to a carbon atom of an organic group having one or more carbon numbers; and the first material is a silicon oxide polymer containing the silicon atom bonded to a carbon atom of an organic group having one or more carbon numbers.

6. The process according to claim 1, wherein the third material having a zeolite-like recurring portion and a silicon oxide portion in an amorphous state and containing a silicon atom bonded to a carbon atom of an organic group having one or more carbon numbers is used as the first and second materials.

7. The process according to claim 1, further comprising a step of sintering the film treated by dry gel conversion method to obtain a porous film.

8. A zeolite-containing film produced by a process according to claim 1.

9. A zeolite-containing porous film prepared by a preparation process according to claim 7.

10. A semiconductor device comprising a zeolite-containing porous film according to claim 9.

11. A process for manufacturing a semiconductor device, comprising the steps of:
forming the zeolite-containing film according to claim 8 on an intermediate substrate for semiconductor manufacture; and
burning the resulting zeolite-containing film to obtain a zeolite-containing porous film.
